(19) United States
(12) Patent Application Publication
(10) Pub. No.: US 2011/0274033 A1
(43) Pub. Date: Nov. 10, 2011

(54) Using Secondary Channel to Activate Primary Channel for Data, Video, and Voice Communication

(75) Inventors: Hui Deng, San Ramon, CA (US); JianMing Tu, Shanghai (CN)

(73) Assignee: ARCSOFT (SHANGHAI) TECHNOLOGY COMPANY, LTD, Shanghai (CN)

(21) Appl. No.: 12/282,404

(22) PCT Filed: Sep. 5, 2008
(86) PCT No.: PCT/US08/75461

§ 371 Date: Sep. 10, 2008

(51) Int. Cl. H04W 4/00

(52) U.S. Cl. 370/328

(57) ABSTRACT

A method is provided so mobile devices can communicate through their wireless data services to a public computer network, which are normally deactivated when not in use. A first device calls a second device over a wireless voice service. The first device activates its wireless data service and sends a request to communicate with the second device to a server on the public computer network. Without answering the voice call, the second device determines an ID of the first device. The second device then activates its wireless data service and sends a query to the server to determine if the first device desires to communicate over the public computer network. The server responds to the request and the query by setting up a network connection between the first and the second device over the public computer network so they can exchange data packets.

### FIELD OF INVENTION

This invention relates mobile devices using wireless data connections to communicate with each other over a public computer network.

### DESCRIPTION OF RELATED ART

Today, many mobile phones offer wireless voice service to make telephone calls, and at least one type of wireless data service to access the Internet. Through the wireless voice service, a mobile phone has a globally unique ID such as a telephone number or a SIM (subscriber identity module) number. The mobile phone typically consumes moderate energy when it uses the wireless voice service or when it is on standby waiting to send or receive calls. For this reason, the wireless data service is normally on unless the user turns it off. However, the wireless voice service typically has a low bandwidth for transmitting data and it may be expensive to use.

The wireless data service provides a mobile phone with a high bandwidth and inexpensive connection to the Internet. However, the mobile phone typically consumes considerable energy when it uses the wireless data service or when it is on standby waiting to send or receive data. For this reason, the wireless data service is normally off unless the user turns it on. The service provider assigns a dynamic network address to the mobile device each time the mobile device activates the wireless data service.

### SUMMARY

In one embodiment of the invention, a method is provided so mobile devices can communicate using their high bandwidth wireless data services to a public computer network, which are normally deactivated when not in use to conserve power consumption. A first device calls a second device over a low bandwidth wireless voice channel to prompt the second device to activate its wireless data service. The two devices activate their wireless data services and contact a server on the public computer network, which sets up a network connection between the two devices over the public computer network for exchanging data packets.

### BRIEF DESCRIPTION OF THE DRAWINGS

FIG. 1 is a diagram of a system for implementing one embodiment of the invention.

FIG. 2 is a diagram of the software architecture of a mobile device in the system of FIG. 1 in one embodiment of the invention.

FIG. 3 is a flowchart of a method for implementing one embodiment of the invention.

FIGS. 4A and 4B are flowcharts of another method for implementing another embodiment of the invention.

FIG. 5 is a flowchart of another method for implementing another embodiment of the invention.

FIGS. 6A and 6B are flowcharts of another method for implementing another embodiment of the invention.

FIG. 7 is a flowchart of another method for implementing another embodiment of the invention.

FIG. 8 is a flowchart of another method for implementing another embodiment of the invention.

Use of the same reference numbers in different figures indicates similar or identical elements.

### DETAILED DESCRIPTION OF THE INVENTION

Mobile phones can send MMS (multimedia messaging service) messages including images, audio, video, and rich text. However, this service is expensive and the size and the format of the message are limited by the service standard.

Mobile phones with wireless data services can connect to the Internet and use communication software to talk, instant message, and exchange pictures, videos, and other files. However, this requires both mobile phones to be connected to the Internet and logged in with the appropriate software at the same time. Often only one mobile phone is connected to the Internet and the user of the online device has to call the user of the offline device to ask the latter to activate his or her wireless data service, connect to the Internet, and log in with the appropriate software so they can communicate over the Internet. This manual process costs both time and money. Alternatively, the mobile phones can remain constantly online. However, this is not suitable for mobile applications as the mobile phones will quickly drain their batteries and will have to be charged frequently. Thus, the present invention provides ways to combine the advantages of the wireless voice and data services so a mobile device has a high bandwidth and inexpensive connection to the Internet, long standby time, and the ability to be reached at any time.

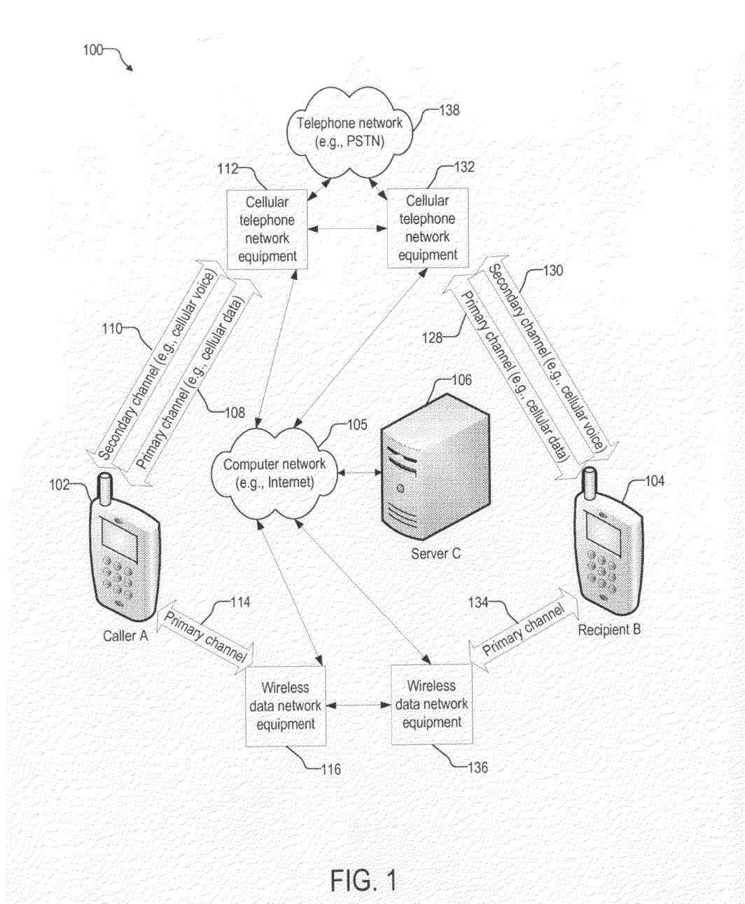

FIG. 1 illustrates a system 100 that allows mobile devices 102 and 104 to communicate wirelessly over a public computer network 105 with the assistance of a server 106 on the network in one embodiment of the invention. Mobile devices 102 and 104 can be any device that has a wireless data service for accessing public computer network 105, and wireless voice service for making telephone calls. Mobile devices 102 and 104 may be mobile phones, portable computers, or satellite phones. Public computer network 105 may be the Internet or another packet data network. Examples of the wireless voice service include GSM, CDMA, WCDMA/DCMA2000/TD-SCDMA, WiMax, and satellite voice services. Examples of the wireless data service include GRPS/EDGE, WCDMA/CDMA2000/TD-SCDMA, WiMax, and satellite data services, or WiFi and Bluetooth connections to another device connected to public computer network 105.

Device 102 has a wireless data channel 108 for accessing public computer network 105, and a wireless voice channel 110 for making calls. Channels 108 and 110 represent connections to cellular telephone network equipment 112 for wireless data and voice services provided by a carrier. Device 102 may have a data channel 114 for accessing network 105. Channel 114 represents a connection to wireless data network equipment 116 for wireless data service provided by the same or different carrier.

Similarly, device 104 has a data channel 128 for accessing public computer network 105, and a voice channel 130 for making calls. Channels 128 and 130 represent connections cellular telephone network equipment 132 for wireless data and voice services provided by a carrier. Device 104 may have a data channel 134 for accessing network 105. Channel 134 represents a connection to wireless data network equipment 132 for wireless data service provided by the same or different carrier.

Cellular telephone network equipment 112 and 132 route calls to and from each other if they are part of the network of the same carrier, or through a telephone network 138 if they are from networks of different carriers. Telephone network 138 is typically a public switched telephone network. Cellular telephone network equipment 112 and 132 also route data to and from network 105. Wireless data network equipment 116 and 136 route data to and from each other if they are part of the network of the same carrier, or through network 105 if they are from networks of different carriers. Server 106 is coupled to public computer network 105.

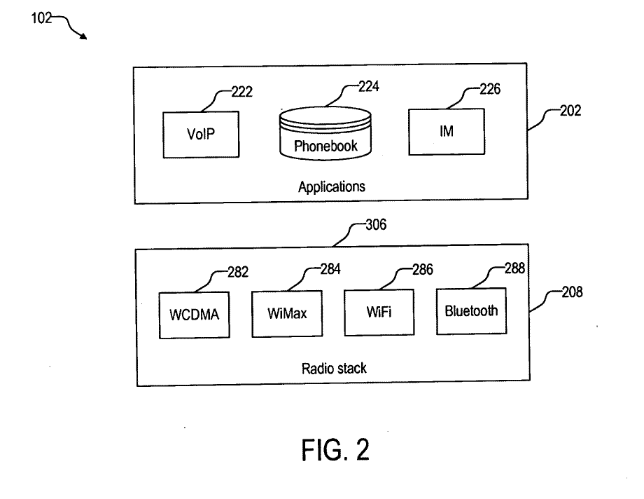

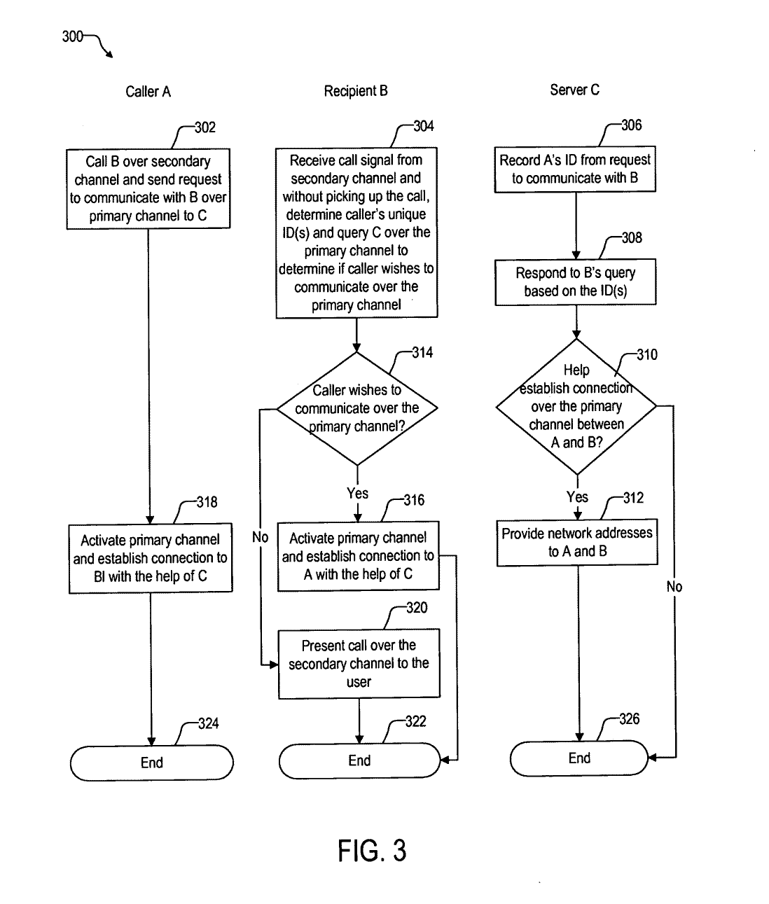

FIG. 2 illustrates the software architecture of device 102 in one embodiment. Device 104 can be similarly configured. The software of device 102 includes applications 202 and a radio stack 208. Applications 202 include a VoIP application 222, a phonebook 224, and an instant messenger 226. The functions of VoIP application 222 and phonebook 224 are described later in reference to FIGS. 3 to 6B.

Radio stack 208 includes components responsible for voice and data communication using various wireless standards. Radio stack 208 includes a cellular voice and data component 282 (e.g., WCDMA), a wireless metropolitan area network component 284 (e.g., WiMax), a wireless local area network component 286 (e.g., WiFi), and a short range wireless network component 288 (e.g., Bluetooth). Although not shown, the software may further include system application logic and APIs for providing interface between components.

FIG. 3 is a flowchart of a method 300 for one mobile device to use its wireless voice service to activate the wireless data service of another device so they can communicate over a computer network in one embodiment of the invention.

To demonstrate method 300, it is assumed the user of mobile device 102 desires to communicate with the user of mobile device 104 over network 105. Method 300 is implemented by processors executing software in the devices. For convenience, mobile device 102, mobile device 104, and server 106 are also referred to as caller A, recipient B, and server C in the figures. Although the steps performed by the devices are described sequentially, they may be also performed in parallel or out of sequence unless stated otherwise.

In step 302, device 102 calls device 104 using wireless voice channel 110 (also referred to as the “secondary channel”). Device 102 also activates its wireless data service and uses wireless data channel 108 or 114 (also referred to as the “primary channel”) to send a request to server 106. The request indicates that device 102 desires to communicate over network 105, and includes one or more unique IDs of device 102. The unique ID can take any form that allows device 104 to identify device 102 in a call. For example, the unique IDs can include (1) a telephone number identifiable by device 104 through caller ID, (2) a SIM card number identifiable by device 104 through the call setup process with cellular telephone network equipment 132, (3) an International Mobile Equipment ID (IMEI) number identifiable by device 104 through the call setup process with cellular telephone network equipment 132, and (4) any other unique ID number of device 102 that is identifiable by device 104 through the call setup. The request may also include one or more unique IDs of the intended recipient (device 104) of the communication.

In step 304, device 104 receives a signal from cellular telephone network equipment 132 indicating an incoming call. Device 104 determines a unique ID of the caller without picking up the call (e.g., the telephone number of device 102 determined from caller ID). As the caller ID may not always correctly identify the telephone number of the caller, especially for long distance calls, device 104 may also determine other unique IDs of the caller (e.g., the SIM card number or the IMEI number of device 102 determined through the call setup process with cellular telephone network equipment 132). Device 104 then activates its wireless data service and uses wireless data channel 128 or 134 to send a query to server 106. The query includes the one or more unique IDs of the caller and the query asks server 106 if the caller desires to communicate over network 105. The query may also include the one or more unique IDs (e.g., telephone number, SIM card number, and IMEI number) of device 104 and ask server 106 if any caller desires to communicate with the device over network 105.

In step 306, server 106 receives the request from device 102, records the one or more unique IDs of device 102, and records the one or more unique IDs of the intended recipient (device 104). Server 106 also records the network address of device 102, which can be determined from the data packets of the request.

In step 308, server 106 receives the query from device 104 and determines if the one or more unique IDs of the caller in the query matches a device in its records that wishes to communicate over network 105. Server 106 may also determine if one or more of the unique IDs of device 104 match a recipient in its record that another device wishes to communicate with over network 105. Server 106 then sends a response to device 104. Server 106 also records the network address of device 104, which can be determined from the data packets of the query.

In step 310, server 106 determines if it has to help devices 102 and 104 establish a connection over network 105. Server 106 has to help if the one or more of unique IDs in the query match a request in its records. If so, step 310 is followed by step 312. Otherwise step 310 is followed by step 326, which ends the actions of server 106.

In step 312, server 106 sends the network address of device 102 to device 104, and vice versa. Step 312 is followed by step 326, which ends the action of server 106.

In step 314, device 104 determines if the caller desires to communicate over network 105 from the response of server 106. If so, step 314 is followed by step 316. Otherwise step 314 is followed by step 320.

In steps 316 and 318, devices 104 and 102 receive the network addresses of the other party from server 106, establish a connection over network 105, cancel the wireless voice call, and start to exchange data packets for the duration of the communication. The data packets may include voice (or other types of sounds), text, image, and video data. The data packets may stem from VoIP application 222, instant messenger 226, or other similar software. Steps 316 and 318 are followed by steps 322 and 324, which end the actions of devices 104 and 102.

In step 320, device 104 presents the call incoming to its user as a regular wireless voice call. At the end of the call, step 320 is followed by step 322, which ends the actions of device 104.

In method 300, device 104 has to contact server 106 to determine (1) of the caller has the capabilities to communicate over network 105 as described in this disclosure, and (2) if the caller currently desires to communicate over network 105. This may cause noticeable delay in the call experiences, especially when a caller without the capabilities described in this disclosure calls device 104.

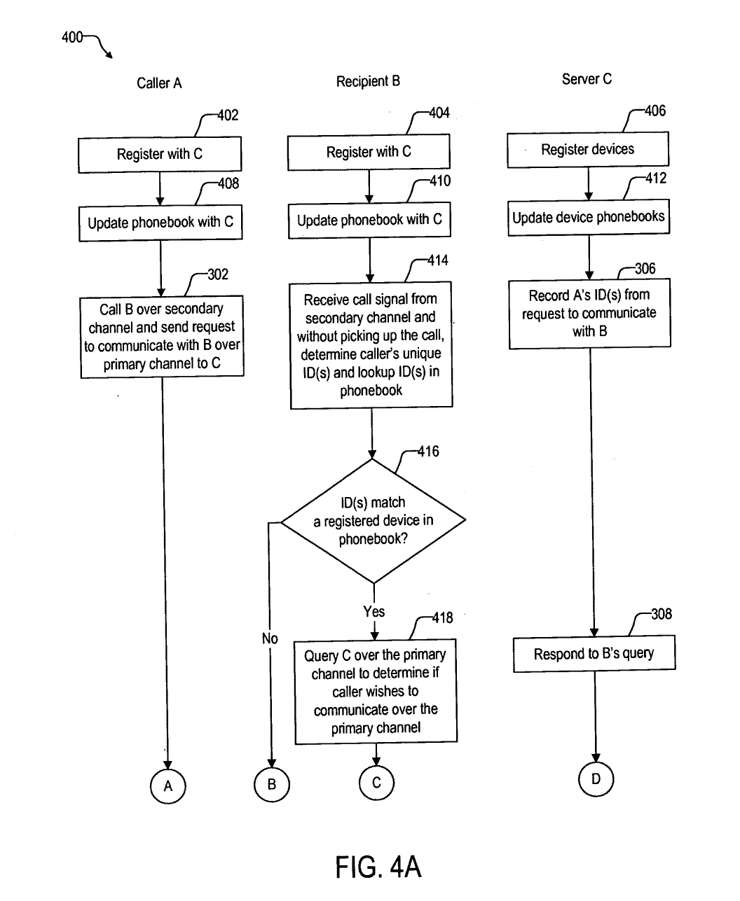

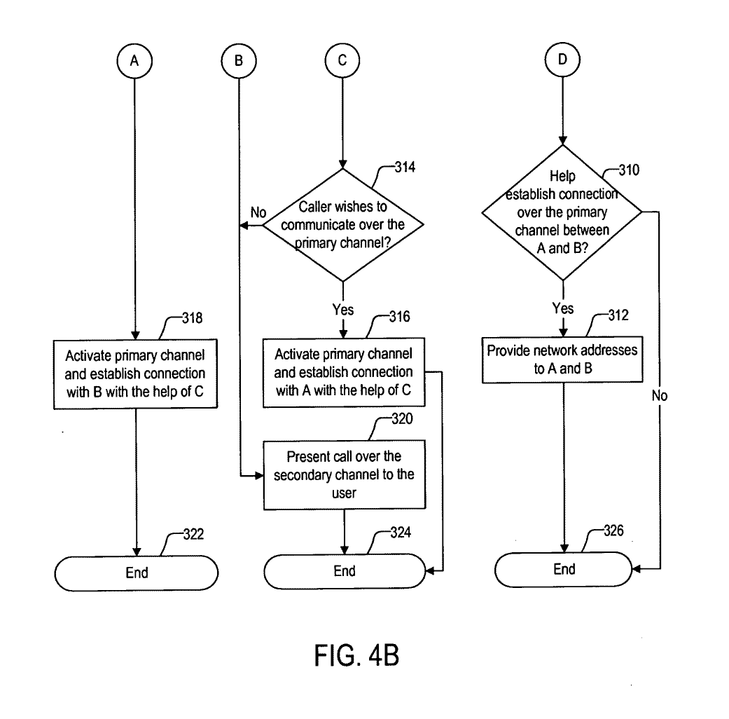

FIGS. 4A and 4B illustrate a flowchart of a method 400 in one embodiment of the invention. Method 400 is similar to method 300 but a registration process is used to expedite the setup and improve the call experience. Common steps with method 300 share the same reference numbers.

To demonstrate method 400, it is assumed the user of mobile device 102 desires to communicate with the user of mobile device 104 over network 105. Although the steps performed by the devices are described sequentially, they may be also performed in parallel or out of sequence unless stated otherwise.

In steps 402 and 404, devices 102 and 104 register with server 106 as devices that are capable of communicating with other devices over network 105 in the manner described in this disclosure. To register, devices 102 and 104 activate their wireless data services and provide their one or more unique IDs through their wireless data channels to server 106.

In step 406, server 106 registers device 102 and 104 by recording the one or more unique IDs. As a condition prior to registering a device, server 106 can verify a unique ID (e.g., the telephone numbers) provided by the device. For example, server 106 can send an instant message to the telephone number provided by each device. The message has an authentication code and a link to a website hosted by server 106. When the device clicks on the link, the device will send the authentication code to server 106, thereby verifying the telephone number provided by the device.

In step 408, device 102 updates phonebook 224 with server 106. Phonebook 224 not only records names and telephone numbers of contacts like a conventional electronic phonebook in mobile phones, but it also records other unique IDs (e.g., SIM card numbers and IMEI numbers) of the devices of the contacts. Device 102 sends all the unique IDs (e.g., the telephone numbers, the SIM card numbers, and the IMEI numbers) of the contacts in phonebook 224 to server 106. Similarly, in step 410, device 104 updates its phonebook with server 106.

In step 412, server 106 looks up the unique IDs in the phonebooks against its records of registered devices. Server 106 then informs devices 102 and 104 of the registered devices found in their phonebooks. Devices 102 and 104 make the appropriate notations in their phonebooks of the registered devices.

In step 302, device 102 calls device 104 using wireless voice channel 110. Device 102 also activates its wireless data service and uses wireless data channel 108 or 114 to send a request to server 106, which includes one or more unique IDs of device 102 and the intended recipient (device 104).

In step 306, server 106 receives the request from device 102 and records the one or more unique IDs of device 102 and the intended recipient. Server 106 also records the network address of device 102, which can be determined from the data packets of the request.

In step 414, device 104 receives a signal from cellular telephone network equipment 132 indicating an incoming call. Device 104 determines a unique ID of the caller without picking up the call (e.g., the telephone number of device 102 determined from caller ID). As the caller ID may not always correctly identify the telephone number of the caller, especially for long distance calls, device 104 may also determine other unique IDs of the caller (e.g., the SIM card number and the IMEI number of device 102 determined through the call setup process with cellular telephone network equipment 132). As described above, the unique ID can take any form that allows device 104 to identify device 102 through the call. Device 104 then looks up the one or more unique IDs in its phonebook to see if the one or more unique IDs belong to a contact and that contact is a registered device.

In step 416, device 104 determines if the one or more unique IDs match that of a registered device in its phonebook. If so, then step 416 is followed by step 418. Otherwise step 416 is followed by step 320.

In step 418, device 104 activates its wireless data service and uses wireless data channel 128 or 134 to send a query to server 106 to determine if the caller desires to communicate over network 105. The query includes the one or more unique IDs of the caller and the query asks server 106 if the caller desires to communicate over network 105. The query may also include the one or more unique IDs (e.g., telephone number, SIM card number, and IMEI number) of device 104 and ask server 106 if any caller desires to communicate with the device over network 105.

In step 308, server 106 receives the query from device 104 and determines if the one or more unique IDs of the caller in the query matches a device in its records that wishes to communicate over network 105. Server 106 may also determine if one or more of the unique IDs of device 104 match a recipient in its record that another device wishes to communicate with over network 105. Server 106 then sends a response to device 104. Server 106 also records the network address of device 104, which can be determined from the data packets of the query.

In step 310, server 106 determines if it has to help devices 102 and 104 establish a connection over network 105. Server 106 has to help if the one or more unique IDs match a request in its records. If so, step 310 is followed by step 312. Otherwise step 310 is followed by step 326, which ends the actions of server 106.

In step 312, server 106 sends the network address of device 102 to device 104, and vice versa. Step 312 is followed by step 326, which ends the action of server 106.

In step 314, device 104 determines if the caller desires to communicate over network 105 from the response of server 106. If so, step 314 is followed by step 316. Otherwise step 314 is followed by step 320.

In steps 316 and 318, devices 104 and 102 receive the network addresses of the other party from server 106, establish a connection over network 105, cancel the wireless voice call, and start to exchange data packets for the duration of the communication. The data packets may include voice (or other types of sounds), text, image, and video data. The data packets may stem from VoIP application 222, instant messenger 226, or other similar software. Steps 316 and 318 are followed by steps 322 and 324, which end the actions of devices 104 and 102.

In step 320, device 104 presents the call incoming to its user as a regular wireless voice call. At the end of the call, step 320 is followed by step 322, which ends the actions of device 104.

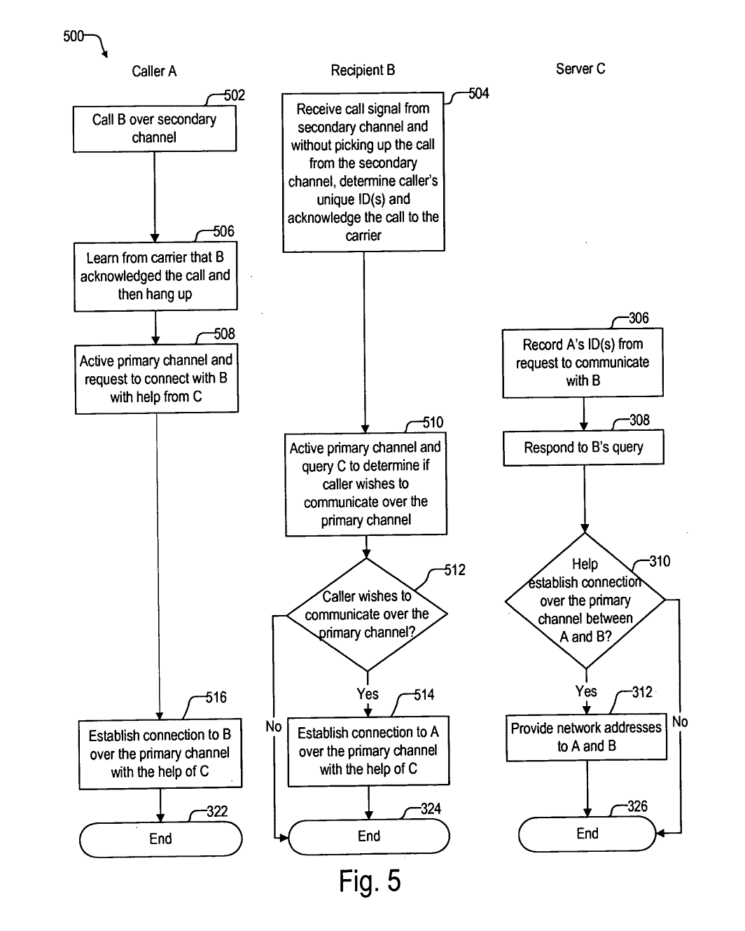

FIG. 5 is a flowchart of a method 500 in one embodiment of the invention. Method 500 is similar to method 300 but modified for mobile devices that cannot operate their wireless voice and data channels simultaneously. For example, a mobile device may not be able to operate GSM for voice and GPRS for data at the same time. Common steps with method 300 share the same reference numbers.

To demonstrate method 500, it is assumed the user of mobile device 102 desires to communicate with the user of mobile device 104 over network 105. Although the steps performed by the devices are described sequentially, they may be also performed in parallel or out of sequence unless stated otherwise.

In step 502, device 102 calls device 104 using wireless voice channel 108.

In step 504, device 104 receives a signal from cellular telephone network equipment 132 indicating an incoming call. Device 104 determines a unique ID of the caller without picking up the call (e.g., the telephone number of device 102 determined from caller ID). As the caller ID may not always correctly identify the telephone number of the caller, especially for long distance calls, device 104 may also determine other unique IDs of the caller (e.g., the SIM card number and the IMEI number of device 102 determined through the call setup process with cellular telephone network equipment 132). As described above, the unique ID can take any form that allows device 104 to identify device 102 through the call. Device 104 then acknowledges receiving the call incoming signal to equipment 132 (e.g., a base station controller).

In step 506, device 102 learns from cellular telephone network equipment 112 that device 104 has acknowledged the call incoming signal, and then cancels the call. As a result of device 102 cancelling the call, device 104 receives a signal from cellular telephone network equipment 132 indicting a canceled call. The short time period between the call incoming signal and the call cancel signal may indicate to device 104 that device 102 is attempting to communicate with it over network 105.

In step 508, device 102 deactivates its wireless voice service, activates its wireless data service, and uses wireless data channel 108 or 114 to send a request to server 106, which includes one or more unique IDs of device 102 and the intended recipient (device 104).

In step 306, server 106 receives the request from device 102 and records the one or more unique IDs of device 102 and the intended recipient. Server 106 also records the network address of device 102, which can be determined from the data packets of the request.

In step 510, device 104 activates its wireless data service and uses wireless data channel 128 or 134 to send a query to server 106 to determine if the caller desires to communicate over network 105. The query includes the one or more unique IDs of the caller and the query asks server 106 if the caller desires to communicate over network 105. The query may also include the one or more unique IDs (e.g., telephone number, SIM card number, and IMEI number) of device 104 and ask server 106 if any caller desires to communicate with the device over network 105.

In step 308, server 106 receives the query from device 104 and determines if the one or more unique IDs of the caller in the query matches a device in its records that wishes to communicate over network 105. Server 106 may also determine if one or more of the unique IDs of device 104 match a recipient in its record that another device wishes to communicate with over network 105. Server 106 then sends a response to device 104. Server 106 also records the network address of device 104, which can be determined from the data packets of the query.

In step 310, server 106 determines if it has to help devices 102 and 104 establish a connection over network 105. Server 106 has to help if the one or more unique IDs match a request in its records. If so, step 310 is followed by step 312. Otherwise step 310 is followed by step 326, which ends the actions of server 106.

In step 312, server 106 sends the network address of device 102 to device 104 over network 105, and vice versa. Step 312 is followed by step 326, which ends the action of server 106.

In step 512, device 104 determines if the caller desires to communicate over network 105 from the response of server 106. If so, step 512 is followed by step 514. Otherwise step 512 is followed by step 324, which ends the actions of device 104.

In steps 514 and 516, devices 104 and 102 receive the network addresses of the other party from server 106, establish a connection over network 105, and start to exchange data packets for the duration of the communication. The data packets may include voice (or other types of sounds), text, image, and video data. The data packets may stem from VoIP application 222, instant messenger 226, or other similar software. Steps 514 and 516 are followed by steps 322 and 324, which ends the action of devices 104 and 102.

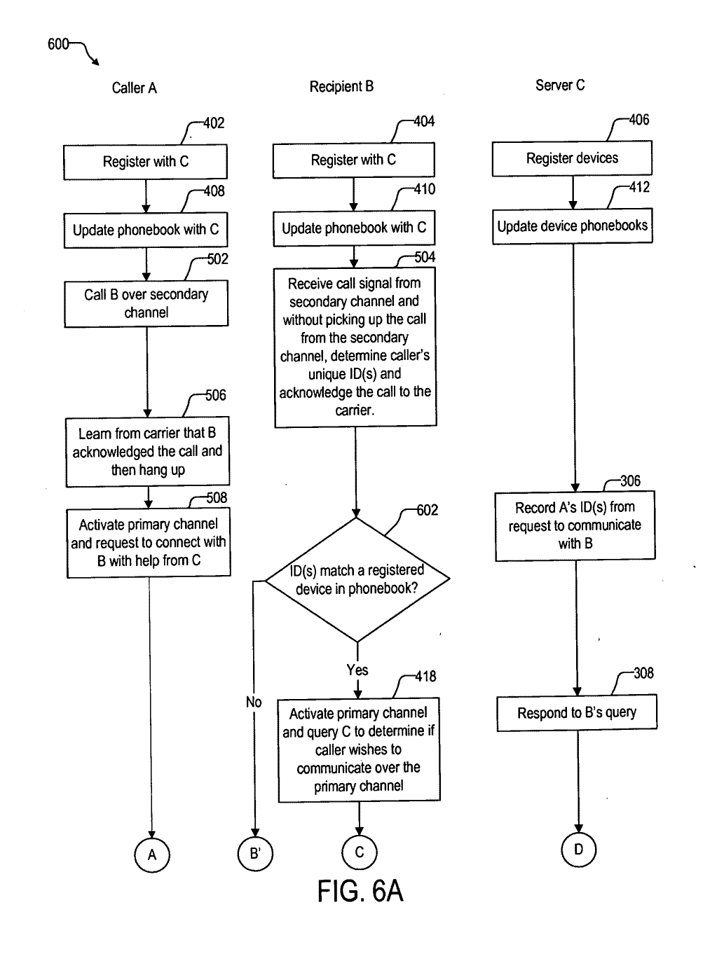

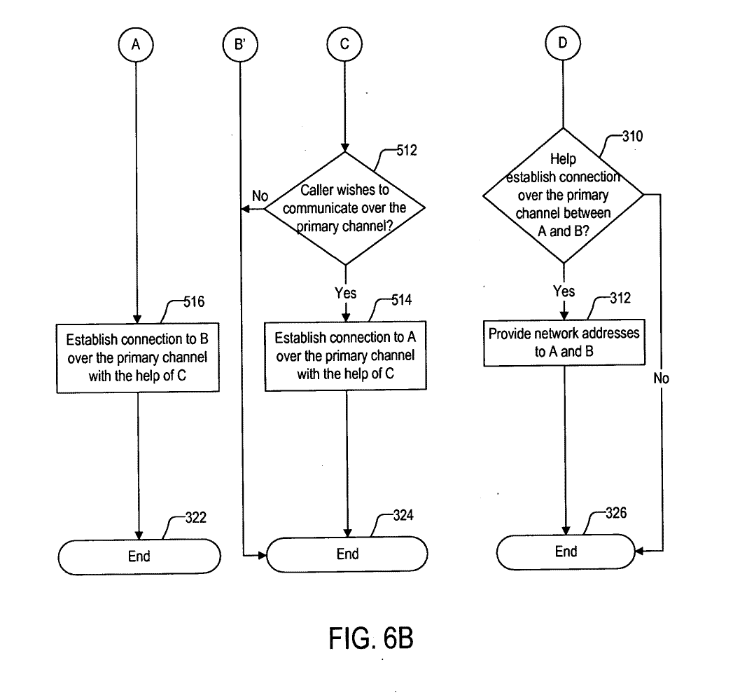

FIGS. 6A and 6B illustrate a flowchart of a method 600 in one embodiment of the invention. Method 600 is similar to method 400 but modified with steps from method 500 for mobile devices that cannot operate their wireless voice and data channels simultaneously. Common steps with methods 400 and 500 share the same reference numbers.

To demonstrate method 600, it is assumed the user of mobile device 102 desires to communicate with the user of mobile device 104 over network 105. Although the steps performed by the devices are described sequentially, they may be also performed in parallel or out of sequence unless stated otherwise.

In steps 402 and 404, devices 102 and 104 registers with server 106 as devices that are capable of communicating with other devices over network 105 in the manner described in this disclosure. To register, devices 102 and 104 activate their wireless data services and provide their one or more unique IDs through their wireless data channels to server 106.

In step 406, server 106 registers device 102 and 104 by recording their unique IDs. As a condition prior to registering devices 102 and 104, server 106 can verify one or more of the unique IDs (e.g., the telephone numbers) provided by the device.

In steps 408, device 102 updates phonebook 224 with server 106. Phonebook 224 not only records names and telephone numbers of contacts like a conventional electronic phonebook, but it also records other unique IDs (e.g., SIM card numbers and IMEI numbers) of the devices of the contacts. Device 102 sends all the unique IDs (e.g., the telephone numbers, the SIM card numbers, and the IMEI numbers) of the contacts in phonebook 224 to server 106. Similarly, in step 410, device 104 updates its phonebook with server 106.

In step 412, server 106 looks up the unique IDs against its records of registered devices. Server 106 then informs devices 102 and 104 of the registered devices found in their phonebooks. Devices 102 and 104 make the appropriate notations in their phonebooks of the registered devices.

In step 502, device 102 calls device 104 using wireless voice channel 108.

In step 504, device 104 receives a signal from cellular telephone network equipment 132 indicating an incoming call. Device 104 determines a unique ID of the caller without picking up the call (e.g., the telephone number of device 102 determined from caller ID). As the caller ID may not always correctly identify the telephone number of the caller, especially for long distance calls, device 104 may also determine other unique IDs of the caller (e.g., the SIM card number and the IMEI number of device 102 determined through the call setup process with cellular telephone network equipment 132). As described above, the unique ID can take any form that allows device 104 to identify device 102 through the call. Device 104 then acknowledges receiving the call incoming signal to equipment 132 (e.g., a base station controller).

In step 506, device 102 learns from cellular telephone network equipment 112 that device 104 has acknowledged the call incoming signal, and then cancels the call. As a result of device 102 cancelling the call, device 104 receives a signal from cellular telephone network equipment 132 indicting a canceled call. The short time period between the call incoming signal and the call cancel signal may indicate to device 104 that device 102 is attempting to communicate with it over network 105.

In step 508, device 102 deactivates its wireless voice service, activates its wireless data service, and uses wireless data channel 108 or 114 to send a request to server 106, which includes the one or more unique IDs of device 102 and the intended recipient (device 104).

In step 306, server 106 receives the request from device 102 and records the unique IDs of from device 102 and the intended recipient.

In step 602, device 104 looks up the one or more unique IDs in its phonebook to see if the one or more unique IDs belong to a contact and that contact is a registered device. If so, then step 602 is followed by step 418. Otherwise step 416 is followed by step 324, which ends the actions of device 104.

In step 418, device 104 activates its wireless data service and uses wireless data channel 128 or 134 to send a query to server 106 to determine if the caller desires to communicate over network 105. The query includes the one or more unique IDs of the caller and the query asks server 106 if the caller desires to communicate over network 105. The query may also include the one or more unique IDs (e.g., telephone number, SIM card number, and IMEI number) of device 104 and ask server 106 if any caller desires to communicate with the device over network 105.

In step 308, server 106 receives the query from device 104 and determines if the one or more unique IDs of the caller in the query matches a device in its records that wishes to communicate over network 105. Server 106 may also determine if one or more of the unique IDs of device 104 match a recipient in its record that another device wishes to communicate with over network 105. Server 106 then sends a response to device 104. Server 106 also records the network address of device 104, which can be determined from the data packets of the query.

In step 310, server 106 determines if it has to help devices 102 and 104 establish a connection over network 105. Server 106 has to help if the one or more unique IDs match a request in its records. If so, step 310 is followed by step 312. Otherwise step 310 is followed by step 326, which ends the actions of server 106.

In step 312, server 106 sends the network address of device 102 to device 104 over network 105, and vice versa. Step 312 is followed by step 326, which ends the action of server 106.

In step 514, device 104 determines if the caller desires to communicate over network 105 from the response of server 106. If so, step 512 is followed by step 514. Otherwise step 512 is followed by step 324, which ends the actions of device 104.

In steps 514 and 516, devices 104 and 102 receive the network addresses of the other party from server 106, establish a connection over network 105, and start to exchange data packets for the duration of the communication. The data packets may include voice (or other types of sounds), text, image, and video data. The data packets may stem from VoIP application 222, instant messenger 226, or other similar software. Steps 514 and 516 are followed by steps 322 and 324, which ends the action of devices 104 and 102.

In methods 300 and 400, device 104 has to contact server 106 to if the caller currently desires to communicate over network 105. This may cause noticeable delay in the call experiences, especially when a caller without the capabilities described in this disclosure calls device 104.

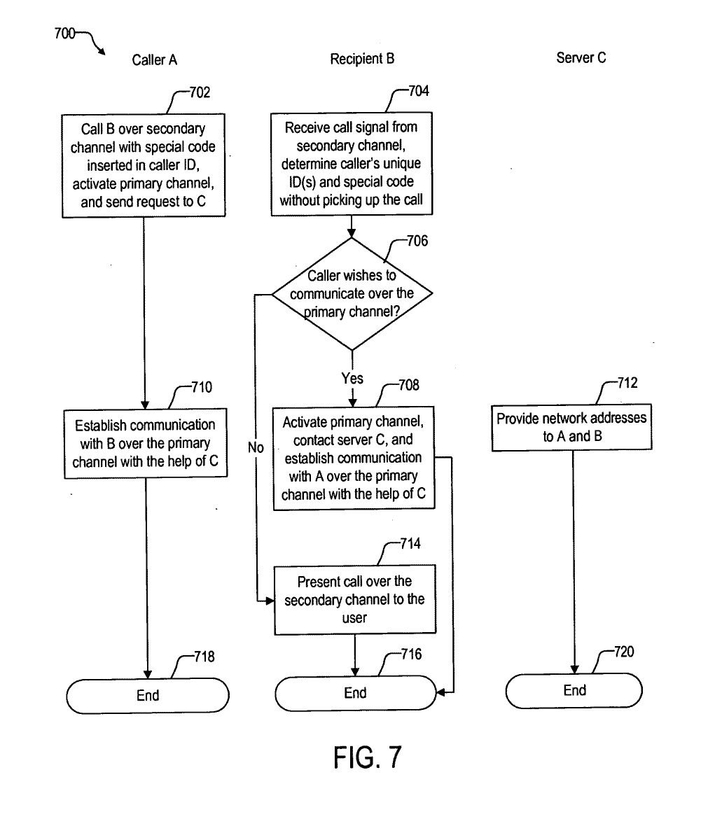

FIG. 7 is a flowchart of a method 700 in one embodiment of the invention. Method 700 is similar to method 300 but a special code in inserted into caller ID information to further expedite the call setup and improve the call experience.

To demonstrate method 700, it is assumed the user of mobile device 102 desires to communicate with the user of mobile device 104 over network 105. Although the steps performed by the devices are described sequentially, they may be also performed in parallel or out of sequence unless stated otherwise.

In step 702, device 102 calls device 104 using wireless voice channel 110. In the call, device 102 inserts a special code in the caller ID information sent to cellular telephone network equipment 112 for device 104. The special code indicates that device 102 wishes to communicate over network 105. Device 102 also activates its wireless data services and uses wireless data channels 108 or 114 to send a request to server 106 for the network address of device 104. In the request, device 102 includes one or more unique IDs of itself and device 104. As described above, the unique IDs can take any form that allows device 104 to identify device 102 through the call.

In step 704, device 104 receives a signal from cellular telephone network equipment 132 indicating an incoming call. Without picking up the call, device 104 determines the one or more unique IDs of the caller (device 102) and any special code inserted into the caller ID information.

In step 706, device 104 determines if the caller desires to communicate over network 105 based on the presence or absence of the special code detected through caller ID. If so, step 706 is followed by step 708. Otherwise step 706 is followed by step 714.

In part of step 708, device 104 activates its wireless data services and uses wireless data channel 128 or 134 to send a request to server 106 for the network address of device 104. In the request, device 104 includes one or more unique IDs of itself and device 102.

In steps 708 and 710, devices 104 and 102 establish a connection over network 105 when server 106 returns the network address of the opposing party, cancel the wireless voice call, and start to exchange data packets for the duration of the communication. The data packets may include voice (or other types of sounds), text, image, and video data. The data packets may stem from VoIP application 222, instant messenger 226, or other similar software. Steps 708 and 710 are followed by steps 716 and 718, which end the actions of devices 104 and 102.

In step 712, server 106 receives the requests from devices 102 and 104, matches the requests from devices 102 and 104 based on the one or more unique IDs in the requests, determine the network addresses of devices 102 and 104 based on the data packets of the requests, and returns the network address of the other party to devices 102 and 104. Step 712 is followed by step 720, which ends the actions of server 106.

In step 714, device 104 presents the call incoming to its user as a regular wireless voice call. At the end of the call, step 714 is followed by step 718, which ends the actions of device 104.

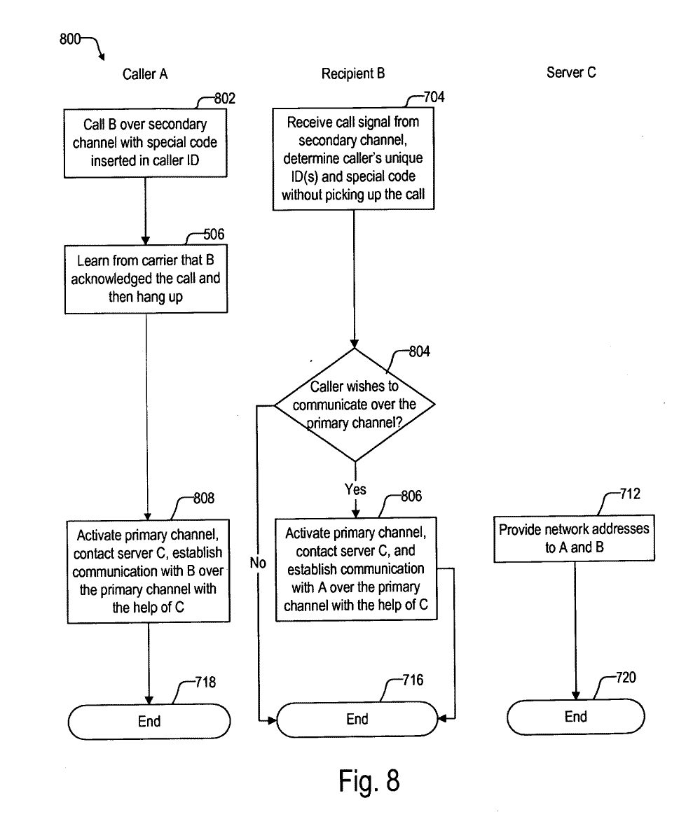

FIG. 8 is a flowchart of a method 800 in one embodiment of the invention. Method 800 is similar to method 700 but modified for mobile devices that cannot operate their wireless voice and data channels simultaneously. Common steps with method 700 share the same reference numbers.

To demonstrate method 800, it is assumed the user of mobile device 102 desires to communicate with the user of mobile device 104 over network 105. Although the steps performed by the devices are described sequentially, they may be also performed in parallel or out of sequence unless stated otherwise.

In step 802, device 102 calls device 104 using wireless voice channel 110. In the call, device 102 inserts a special code in the caller ID information sent to cellular telephone network equipment 112 for device 104. The special code indicates that device 102 wishes to communicate over network 105.

In step 704, device 104 receives a signal from cellular telephone network equipment 132 indicating an incoming call. Without picking up the call, device 104 determines one or more unique IDs of the caller (device 102) and any special code inserted into the caller ID information.

In step 506, device 102 learns from cellular telephone network equipment 112 that device 104 has acknowledged the call incoming signal, and then cancels the call.

In step 804, device 104 determines if the caller desires to communicate over network 105 based on the presence or absence of the special code detected through caller ID. If so, step 804 is followed by step 806. Otherwise step 804 is followed by step 716, which ends the actions of device 104.

In steps 806 and 808, devices 102 and 104 deactivates their wireless voice services, activate their wireless data services, and use their wireless data channels to send requests to server 106 for the opposing party's network address. In the request, devices 102 and 104 include one or more unique IDs of themselves and the other party. When server 106 returns the network address of the opposing party, devices 102 and 104 establish a connection over network 105 and start to exchange data packets for the duration of the communication. The data packets may include voice (or other types of sounds), text, image, and video data. The data packets may stem from VoIP application 222, instant messenger 226, or other similar software. Steps 806 and 8008 are followed by steps 716 and 718, which end the actions of devices 104 and 102.

In step 712, server 106 receives the requests from devices 102 and 104, matches the requests from devices 102 and 104 based on the unique IDs in the requests, determine the network addresses of devices 102 and 104 based on the data packets of the requests, and returns the network address of the other party to devices 102 and 104. Step 712 is followed by step 720, which ends the actions of server 106.

Various other adaptations and combinations of features of the embodiments disclosed are within the scope of the invention. Numerous embodiments are encompassed by the following claims.

1. A method for a wireless mobile device to initiate communication with another device over a public computer network by calling the other device using a wireless voice service of the wireless mobile device, comprising:
calling the other device using the wireless voice service of the wireless mobile device;
activating a wireless data service of the wireless mobile device for accessing a public computer network, the wireless data service being inactivated when not in use;
sending, to a server on the public computer network, a request to establish a network connection with the other device over the public computer network;
establishing the network connection with the other device over the public computer network with help from the server; and
exchanging data packets with the other device over the public computer network.

2. The method of claim 1, wherein the request includes at least one unique ID of the wireless mobile device.

3. The method of claim 2, wherein the unique ID being selected from the group consisting of a telephone number, a SIM card number, and an IMEI number.

4. The method of claim 1, wherein said establishing the network connection includes receiving a network address of the other device from the server.

5. The method of claim 1, further comprising registering with the server.

6. The method of claim 5, further comprising receiving unique IDs of other registered devices from the server.

7. The method of claim 6, wherein the unique IDs of the other registered devices are selected from the group consisting of telephone numbers, SIM card numbers, and IMEI numbers.

8. The method of claim 1, further comprising:
learning through the wireless voice service that the other device acknowledges the call; and
canceling the call after said learning.

9. The method of claim 1, wherein said calling and said sending occur in parallel or in sequence.

10. The method of claim 1, wherein:
the wireless voice service is provided by one of a cellular network and a satellite network; and
the wireless data service is provided by one of the cellular network, a WIMAX network, a WiFi network, and a Bluetooth network.

11. The method of claim 1, wherein said calling includes sending a code in caller ID information, the code indicating a desire to communicate with the other device over the public computer network.

12. A method for a wireless mobile device to accept communication with another device over a public computer network by receiving a call from the other device through a wireless voice service of the wireless mobile device, comprising:
receiving the call from the other device through the wireless voice service of the wireless mobile device;
determining at least one unique ID of the other device without picking up the call;
activating a wireless data service of the wireless mobile device for accessing the public computer network, the wireless data service being inactivated when not in use;
establishing a network connection with the other device over the public computer network with help from a server on the public computer network; and
exchanging data packets with the other device over the public computer network.

13. The method of claim 12, further comprising, prior to said a network connection with the other device:
sending, to a server on the public computer network, a query to determine if the other device desires to establish a network connection over the public computer network, wherein said establishing and said exchanging occur when the other device desires to establish a network connection over the public computer network.

14. The method of claim 13, wherein the query includes at least the unique ID of the other device, the unique ID being selected from the group consisting of a telephone number, a SIM card number, and an IMEI number.

15. The method of claim 13, wherein the query includes at least one unique ID of the wireless mobile device, the unique ID being selected from the group consisting of a telephone number, a SIM card number, and an IMEI number.

16. The method of claim 13, further comprising:
when the other device does not desire to communicate over the cellular network using the data protocol, presenting the call to a user.

17. The method of claim 12, wherein said establishing a network connection with the other device includes receiving a network address of the other device from the server.

18. The method of claim 12, further comprising registering with the server.

19. The method of claim 18, further comprising receiving unique IDs of other registered devices from the server.

20. The method of claim 19, wherein the unique IDs of the other registered devices are selected from the group consisting of a telephone number, a SIM card number, and an IMEI number.

21. The method of claim 19, further comprising, prior to said activating and said sending:
saving the unique IDs in a phonebook; and
determining if the unique ID of the other device is in the phonebook, wherein said activating and said establishing occur when the unique ID of the other device is in the phonebook.

22. The method of claim 21, further comprising:
when the unique ID of the other device is not in the phonebook, presenting the call to a user.

23. The method of claim 13, wherein said receiving a call and said sending a query occur in parallel or in sequence.

24. The method of claim 12, wherein:
the wireless voice service is provided by one of a cellular network and a satellite network; and
the wireless data service is provided by one of the cellular network, a WIMAX network, a WiFi network, and a Bluetooth network.

25. The method of claim 12, further comprising, after said receiving and prior to activating:
determining if caller ID information of the other device includes a code indicating the other device desires to communicate over the cellular network using the data protocol, said activating occurring when the code is present.

26. A method for a server to facilitate a connection between devices over a public computer network, comprising:
registering a device by receiving a unique ID of the device over the public computer network and recording the unique ID;
receiving unique IDs of devices from the device over the public computer network;
cross-referencing the unique IDs with devices registered with the server;
informing the device of registered devices determined from the unique IDs; and
facilitating the connection between the device and another device.

27. The method of claim 26, wherein said facilitating the connection between the device and another device comprises:
receiving a request from the device to communicate with the other device, the request including at least one of the unique ID of the device and an unique ID of the other device;
receiving a query from the other device asking if another device wishes to communicate with the other device, the query including at least one of the unique ID of the device and the unique ID of the other device; and
providing at least a network address of one of the device and the other device to the other one of the device and the other device.

28. The method of claim 26, wherein the unique IDs are selected from the group consisting of telephone numbers, SIM card numbers, and IMEI numbers.
